(19) United States
(12) Patent Application Publication
(10) Pub. No.: US 2022/0392007 A1
(43) Pub. Date: Dec. 8, 2022

(54) SUPPORT SERVER, DISASTER SUPPORT SYSTEM, AND PROGRAM

(71) Applicant: TOYOTA JIDOSHA KABUSHIKI KAISHA, Toyota-shi (JP)

(72) Inventors: Yusuke HOKI, Mishima-shi (JP); Koseki SUGIYAMA, Sunto-gun (JP); Kumiko KATSUMATA, Susono-shi (JP); Rie YAYABE, Sunto-gun (JP); Shin SAKURADA, Toyota-shi (JP); Tomio YAMANAKA, Nagoya-shi (JP)

(73) Assignee: TOYOTA JIDOSHA KABUSHIKI KAISHA, Toyota-shi (JP)

(21) Appl. No.: 17/723,670

(22) Filed: Apr. 19, 2022

(30) Foreign Application Priority Data
Jun. 2, 2021 (JP) 2021-093232

(51) Int. Cl. G06Q 50/26; G06Q 50/06; G06Q 20/36

(52) U.S. Cl. CPC G06Q 50/265; G06Q 50/06; G06Q 20/36; G07C 9/00896

(57) ABSTRACT

A support server includes a processor configured to perform: acquiring an amount of residual fuel, state information of each of a plurality of vehicles, position information of each of the plurality of vehicles, and user position information of a user who desires supply of fuel from the plurality of vehicles; identifying a supply vehicle that is able to supply fuel out of the plurality of vehicles based on the amounts of residual fuel of the plurality of vehicles and the state information of the plurality of vehicles; generating fuel position information including at least the position information of the supply vehicle based on the user position information and the position information of the supply vehicle; and outputting the fuel position information.

### CROSS-REFERENCE TO RELATED APPLICATION

This application claims priority to Japanese Patent Application No. 2021-093232 filed on Jun. 2, 2021, incorporated herein by reference in its entirety.

### BACKGROUND

### 1. Technical Field

The present disclosure relates to a support server, a disaster support system, and a program.

### 2. Description of Related Art

Japanese Unexamined Patent Application Publication No. 2016-208689 (JP 2016-208689 A) discloses a technique of enabling selection of supply of electric power based on engine operation and supply of electric power based on engine stoppage according to a change of a state of charge (SOC) of a power storage device.

### SUMMARY

When a disaster or the like occurs, it is important to supply electric power from a vehicle, but supply of electric power may not be possible according to an amount of residual fuel used for an engine, and thus it is necessary to secure fuel in cooperation with nearby vehicles. In JP 2016-208689 A, cooperation with nearby vehicles is not considered at all.

The present disclosure provides a support server, a disaster support system, and a program that can cooperate with nearby vehicles.

According to the present disclosure, there is provided a support server including a processor configured to perform: acquiring an amount of residual fuel, state information of each of a plurality of vehicles, position information of each of the plurality of vehicles, and user position information of a user who desires supply of fuel from the plurality of vehicles; identifying a supply vehicle that is able to supply fuel out of the plurality of vehicles based on the amounts of residual fuel and the state information; generating fuel position information including at least the position information of the supply vehicle based on the user position information and the position information of the supply vehicle; and outputting the fuel position information.

According to the present disclosure, it is possible to achieve cooperation with nearby vehicles.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram schematically illustrating a configuration of a disaster support system according to an embodiment;

FIG. 2 is a block diagram illustrating a functional configuration of a vehicle according to the embodiment;

FIG. 3 is a block diagram illustrating a functional configuration of a support server according to the embodiment;

FIG. 4 is a flowchart schematically illustrating a routine which is performed by the support server according to the embodiment; and

FIG. 5 is a diagram illustrating an example of fuel position information which is generated by a generation unit of the support server.

### DETAILED DESCRIPTION OF EMBODIMENTS

Hereinafter, a support server, a disaster support system, and a program according to an embodiment of the present disclosure will be described with reference to the accompanying drawings. The present disclosure is not limited to the following embodiment. In the following description, the same elements will be referred to by the same reference signs.

### First Embodiment

Configuration of Disaster Support System

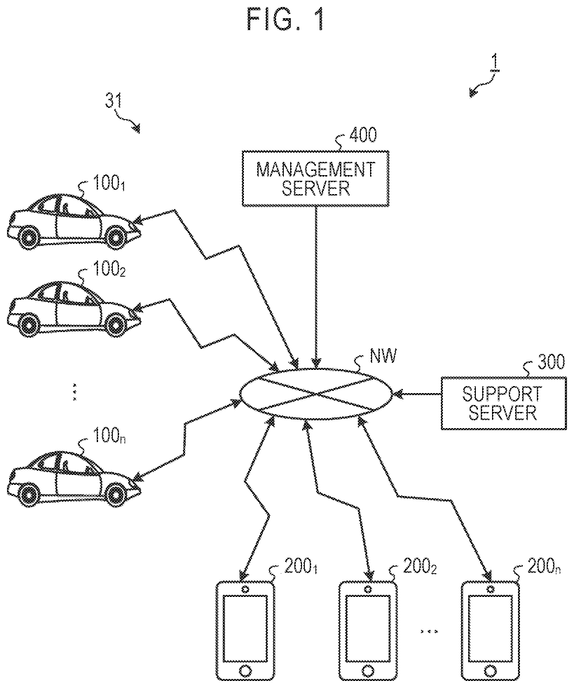

FIG. 1 is a diagram schematically illustrating a configuration of a disaster support system according to an embodiment. The disaster support system 1 illustrated in FIG. 1 includes a plurality of vehicles 100₁ to 100ₙ (where n is an integer equal to or greater than 3) (hereinafter simply referred to as a “vehicle 100” when one of the plurality of vehicles 100₁ to 100ₙ is mentioned), a plurality of communication devices 200₁ to 200ₙ (hereinafter simply referred to as a “communication device 200” when one of the plurality of communication devices 200₁ to 200ₙ is mentioned) correlated with the plurality of vehicles 100₁ to 100ₙ, a support server 300 that can communicate with the vehicles 100, the communication devices 200, and a management server 400 via a network NW, and a management server 400 that can communicate with the support server 300 and the communication devices 200 via the network NW. The network NW is realized, for example, by an Internet network or a mobile phone network.

Each vehicle 100 is realized by one of a hybrid vehicle (HV), a plug-in hybrid vehicle (PHV), a plug-in hybrid electric vehicle (PHEV), and a fuel-cell electric vehicle (FCEV). A detailed configuration of the vehicle 100 will be described later.

Each communication device 200 can communicate with the vehicle 100 according to a predetermined communication protocol and can communicate with the support server 300 and the management server 400 via the network NW. Here, the predetermined communication protocol is at least one of Bluetooth (registered trademark) and Wi-Fi (registered trademark). The communication device 200 is realized, for example, by a communication terminal such as a mobile phone or a tablet.

The support server 300 can communicate with the vehicle 100, the communication device 200, and the management server 400 via the network NW and outputs information for supporting a user when a disaster occurs. A detailed configuration of the support server 300 will be described later.

The management server 400 manages a plurality of different means of payment that is means of payment correlated with the communication devices 200 via the network NW and that is operated by a plurality of business operators and registered in wallets representing a deposit or withdrawal account for electronic money or points.

Functional Configuration of Vehicle

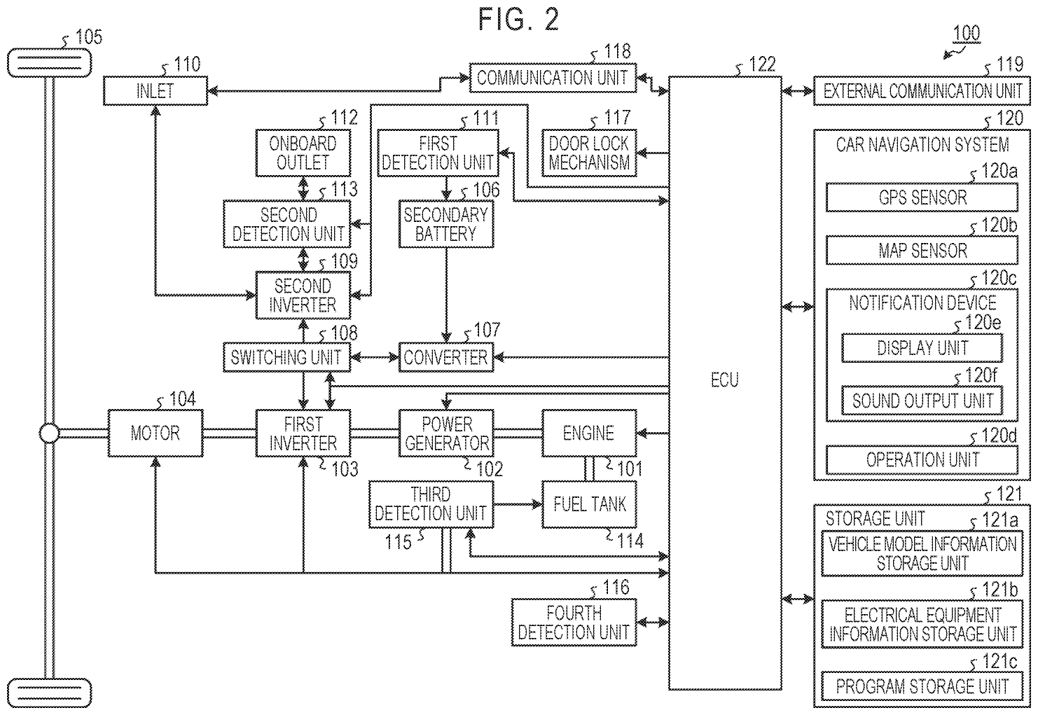

A detailed functional configuration of the vehicle 100 will be described below. FIG. 2 is a block diagram illustrating the functional configuration of the vehicle 100. As illustrated in FIG. 2, the vehicle 100 includes an engine 101, a power generator 102, a first inverter 103, a motor 104, driving wheels 105, a secondary battery 106, a converter 107, a switching unit 108, a second inverter 109, an inlet 110, a first detection unit 111, an onboard outlet 112, a second detection unit 113, a fuel tank 114, a third detection unit 115, a fourth detection unit 116, a door lock mechanism 117, a communication unit 118, an external communication unit 119, a car navigation system 120, a storage unit 121, and an electronic control unit (ECU) 122.

The engine 101 is configured as a known internal combustion engine and outputs power using fuel stored in the fuel tank 114. The engine 101 is driven under the control of the ECU 122. The power output from the engine 101 drives the power generator 102.

The power generator 102 is electrically connected to the motor 104 via the first inverter 103. The power generator 102 supplies generated AC electric power to the secondary battery 106 via the switching unit 108 and the converter 107 under the control of the ECU 122. The power generator 102 is configured as a power-generation motor generator having a motor function in addition to a power generation function.

The first inverter 103 converts discharged electric power (DC electric power) supplied from the secondary battery 106 via the switching unit 108 and the converter 107 to AC electric power under the control of the ECU 122 and supplies the AC electric power to the motor 104. Under the control of the ECU 122, the first inverter 103 converts AC electric power generated by the motor 104 at the time of regenerative braking of the vehicle 100 to DC electric power and supplies the DC electric power to the secondary battery 106 via the switching unit 108 and the converter 107. The first inverter 103 is configured as, for example, a three-phase inverter circuit including a bridge circuit including switching elements corresponding to three phases.

The motor 104 is driven using AC electric power supplied from the first inverter 103 at the time of acceleration of the vehicle 100 under the control of the ECU 122. Power output from the motor 104 drives the driving wheels 105. Under the control of the ECU 122, the motor 104 serves as a power generator that generates electric power using an external force transmitted from the driving wheels 105 at the time of braking of the vehicle 100 and supplies the generated electric power from the first inverter 103 to the secondary battery 106 via the switching unit 108 and the converter 107. The motor 104 is configured as a driving motor generator having a power generation function in addition to a motor function.

The secondary battery 106 is configured as, for example, a rechargeable storage battery such as a nickel-hydride battery or a lithium-ion battery or a power storage device such as an electric double-layer capacitor. The secondary battery 106 can be charged or discharged by the converter 107 and stores DC electric power with a high voltage.

One end of the converter 107 is electrically connected to the secondary battery 106 and the other end is electrically connected to one of the first inverter 103 and the second inverter 109 via the switching unit 108. The converter 107 charges or discharges the secondary battery 106 under the control of the ECU 122. Specifically, when the secondary battery 106 is charged, the converter 107 steps down DC electric power supplied from the outside via the second inverter 109, the inlet 110, and the switching unit 108 to a predetermined voltage and supplies a charging current of the stepped-down voltage to the secondary battery 106. On the other hand, when the secondary battery 106 is discharged, the converter 107 steps up a voltage of DC electric power from the secondary battery 106 and supplies a discharging current of the stepped-up voltage to the first inverter 103 via the switching unit 108.

One end of the switching unit 108 is electrically connected to the converter 107, and the other end thereof is electrically connected to one of the first inverter 103 and the second inverter 109. The switching unit 108 electrically connects the converter 107 to one of the first inverter 103 and the second inverter 109 under the control of the ECU 122. The switching unit 108 is configured using a mechanical relay, a semiconductor switch, or the like.

One end of the second inverter 109 is electrically connected to the switching unit 108, and the other end thereof is electrically connected to the inlet 110 or the onboard outlet 112. Under the control of the ECU 122, the second inverter 109 converts discharged electric power (DC electric power) supplied from the secondary battery 106 via the switching unit 108 and the converter 107 to AC electric power and supplies the AC electric power to the inlet 110. Specifically, the second inverter 109 supplies AC electric power to the outside via the inlet 110 and a charging/discharging cable (not illustrated) under the control of the ECU 122. The second inverter 109 is configured as a single-phase inverter circuit or the like to correspond to a type of electric power which is used in the outside.

One end of the inlet 110 is electrically connected to the second inverter 109. A charging/discharging cable (not illustrated) is detachably connected to the inlet 110. The inlet 110 supplies AC electric power supplied from the outside via the charging/discharging cable to the second inverter 109 and outputs various types of information including a control signal input from the outside to the communication unit 118. The inlet 110 supplies AC electric power supplied from the second inverter 109 to the outside via the charging/discharging cable and outputs various types of information including a control signal input from the ECU 122 to the outside via the communication unit 118.

The first detection unit 111 detects a state of charge (SOC), a temperature, a state of health (SOH), a voltage value, and a current value of the secondary battery 106 and outputs these results of detection to the ECU 122. The first detection unit 111 is configured using a current meter, a voltage meter, a temperature sensor, and the like.

The onboard outlet 112 is electrically connected to the second inverter 109. The onboard outlet 112 can be connected to a power supply plug of a general electronic product and supplies AC electric power supplied from the second inverter 109 to the electronic product of which the power supply plug is connected thereto.

The second detection unit 113 is provided between the onboard outlet 112 and the second inverter 109, detects at least one of power consumption and a current value of electric equipment connected to the onboard outlet 112, and outputs this result of detection to the ECU 122. The second detection unit 113 is configured using a power meter, a current meter, a voltage meter, and the like.

The fuel tank 114 stores fuel to be supplied to the engine 101. Fossil fuel such as gasoline is used as the fuel. When the vehicle 100 is an FCEV, the fuel tank 114 stores hydrogen fuel.

The third detection unit 115 detects an amount of residual fuel stored in the fuel tank 114 and outputs this result of detection to the ECU 122. The third detection unit 115 is configured using a fuel meter or the like.

The fourth detection unit 116 detects state information of the vehicle 100 and outputs this result of detection to the ECU 122. Here, the state information includes an acceleration, an inclination angle, and a speed of the vehicle 100. The fourth detection unit 116 is configured using an acceleration sensor, a speed sensor, a gyro sensor, and the like.

The door lock mechanism 117 performs an operation of opening and closing a door provided in the vehicle 100 under the control of the ECU 122.

The communication unit 118 receives a control signal including various types of information input from the outside via the inlet 110 and outputs the received control signal to the ECU 122. The communication unit 118 outputs a control signal including CAN data or the like input from the ECU 122 to the inlet 110. The communication unit 118 is configured using a communication module or the like.

The external communication unit 119 transmits various types of information input from the ECU 122 to the communication device 200 according to a predetermined communication protocol under the control of the ECU 122. The external communication unit 119 outputs various types of information received from the communication device 200 to the ECU 122. Here, the predetermined communication protocol is at least one of Wi-Fi (registered trademark) and Bluetooth (registered trademark). The external communication unit 119 is configured using a radio communication module or the like.

The car navigation system 120 includes a global positioning system (GPS) sensor 120a, a map database 120b, a notification device 120c, and an operation unit 120d.

The GPS sensor 120a receives signals from a plurality of GPS satellites or transmission antennas and calculates position information on a position (longitude and latitude) of the vehicle 100 based on the received signals. The GPS sensor 120a is configured using a GPS receiver sensor or the like. In the first embodiment, improvement in direction accuracy of the vehicle 100 may be achieved by mounting a plurality of GPS sensors 120a in the vehicle 100.

The map database 120b stores various types of map data. The map database 120b is configured using a storage medium such as a hard disk drive (HDD) or a solid state drive (SSD).

The notification device 120c includes a display unit 120e that displays an image, a map, a video, and text information and a sound output unit 120f that generates sound such as voice or warning sound. The display unit 120e is configured using a display such as a liquid crystal display or an electroluminescence (EL) display. The sound output unit 120f is configured using a speaker or the like.

The operation unit 120d receives an input of a user's operation and outputs signals corresponding to the received various operations to the ECU 122. The operation unit 120d is realized using a touch panel, buttons, switches, a jog dial, or the like.

The car navigation system 120 having the aforementioned configuration notifies a user of information including a road on which the vehicle 100 is traveling and a travel route to a destination using the display unit 120e and the sound output unit 120f by overlapping position information on the current position of the vehicle 100 acquired by the GPS sensor 120a on a map corresponding to map data stored in the map database 120b.

The storage unit 121 stores various types of information on the vehicle 100. The storage unit 121 stores CAN data of the vehicle 100 input from the ECU 122, data under various processes which are performed by the ECU 122, and the like. The storage unit 121 includes a vehicle model information storage unit 121a associated with the vehicle 100, an electrical equipment information storage unit 121b in which a plurality of pieces of electrical equipment registered in advance is correlated with power consumption thereof, and a program storage unit 121c that stores various programs which are executed by the vehicle 100. Here, the vehicle model information includes a vehicle model of the vehicle 100, identification information for identifying the vehicle 100, a production year of the vehicle 100, information indicating whether power generation is performed, and information indicating one of EV, HV, PHV, and FCEV. The storage unit 121 is configured using a DRAM, a ROM, a flash memory, an SSD, or the like.

The ECU 122 is configured using a processor including a memory and hardware such as a central processing unit (CPU). The ECU 122 controls operations of constituent units of the vehicle 100.

Functional Configuration of Support Server

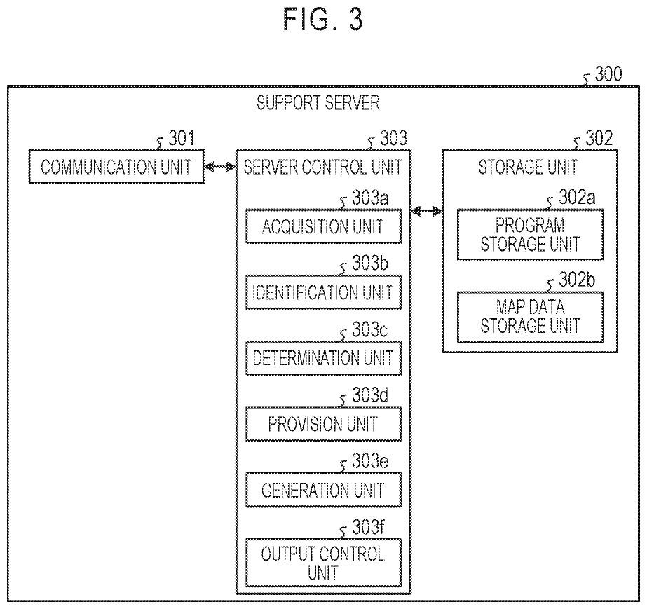

A functional configuration of the support server 300 will be described below. FIG. 3 is a block diagram illustrating the functional configuration of the support server 300. The support server 300 illustrated in FIG. 3 includes a communication unit 301, a storage unit 302, and a server control unit 303.

Under the control of the server control unit 303, the communication unit 301 receives various types of information from the vehicles 100 or the communication devices 200 via the network NW and transmits various types of information to the vehicles 100 or the communication devices 200. The communication unit 301 is configured using a communication module that can transmit and receive various types of information.

The storage unit 302 stores various types of information on the support server 300. The storage unit 302 includes a program storage unit 302a that stores various programs which are executed by the support server 300 and a map data storage unit 302b that stores map data. The storage unit 302 is configured using a DRAM, a ROM, a flash memory, an HDD, an SSD, or the like.

The server control unit 303 controls constituents units of the support server 300. The server control unit 303 is configured using a processor including a memory and hardware such as a CPU. The server control unit 303 includes an acquisition unit 303a, an identification unit 303b, a determination unit 303c, a provision unit 303d, a generation unit 303e, and an output control unit 303f.

The acquisition unit 303a acquires an amount of residual fuel, state information, and position information each of a plurality of vehicles 100₁ to 100ₙ from the plurality of vehicles 100₁ to 100ₙ located in a disaster area and position information of a user (user position information) which desires supply of fuel via the network NW and the communication unit 301.

The identification unit 303b identifies a supply vehicle that can supply fuel out of the plurality of vehicles 100₁ to 100ₙ based on the amount of residual fuel and the position information of each of the plurality of vehicles 100₁ to 100ₙ. Specifically, the identification unit 303b identifies a stopped vehicle which has stopped or a disabled vehicle which is out of order out of the plurality of vehicles 100₁ to 100ₙ as the supply vehicle based on the state information of the each of the plurality of vehicles 100₁ to 100ₙ.

The determination unit 303c determines whether disaster information has been received from an external server (not illustrated) via the network NW and the communication unit 301. The determination unit 303c determines whether permission information for permitting supply of fuel has been received from the supply vehicle or the communication device 200 correlated with the supply vehicle via the network NW and the communication unit 301.

The provision unit 303d performs a provision process of providing electronic money or points corresponding to the amount of residual fuel or the amount of supplied fuel to one of a plurality of different means of payment which is registered in a wallet server representing deposit or withdrawal accounts for electronic money or points and which is operated by a plurality of business operators as a means of payment which a provider of fuel managed by the management server 400 has registered using the communication device 200 via the network NW and the communication unit 301.

The generation unit 303e generates fuel position information based on the map data stored in the map data storage unit 302b, the position information and the amount of residual fuel of the supply vehicle identified by the identification unit 303b, and the position information and the amount of residual fuel of the vehicle 100 correlated with the communication device 200 having received sale request information.

The output control unit 303f outputs the fuel position information to the communication device 200 of the user or the vehicle 100 correlated with the communication device 200. The output control unit 303f outputs fuel supply request information for requesting supply of fuel to at least one of the supply vehicle and the communication device 200 correlated with the supply vehicle via the network NW and the communication unit 301. The output control unit 303f outputs unlocking information for unlocking a door to the supply vehicle having received permission information.

Routine of Support Server

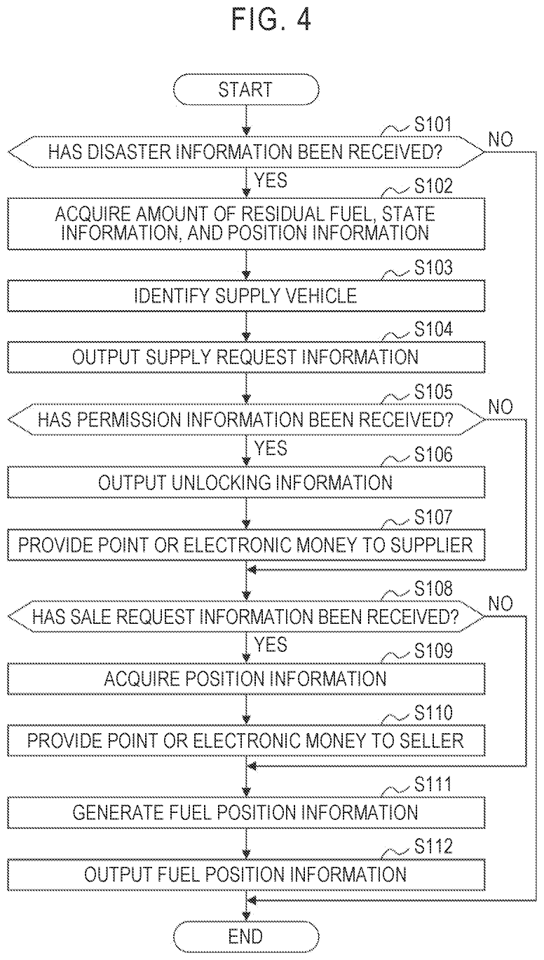

A routine which is performed by the support server 300 will be described below. FIG. 4 is a flowchart schematically illustrating the routine which is performed by the support server 300.

As illustrated in FIG. 4, first, the determination unit 303c determines whether disaster information has been received from an external server (not illustrated) via the network NW and the communication unit 301 (Step S101). When determination unit 303c determines that disaster information has bene received from the external server via the network NW and the communication unit 301 (Step S101: YES), the support server 300 causes the routine to proceed to Step S102. On the other hand, when the determination unit 303c determines that disaster information has not been received from the external server via the network NW and the communication unit 301 (Step S101: NO), the support server 300 ends this routine.

In Step S102, the acquisition unit 303a acquires an amount of residual fuel, state information, and position information each of a plurality of vehicles 100₁ to 100ₙ from the plurality of vehicles 100₁ to 100ₙ located in a disaster area and position information of a user (user position information) which desires supply of fuel via the network NW and the communication unit 301. Specifically, the acquisition unit 303a acquires the amount of residual fuel in the fuel tank 114 detected by the third detection unit 115 of the vehicle 100, state information of the vehicle 100 detected by the fourth detection unit 116, and position information of the vehicle 100 detected by the GPS sensor 120a via the network NW and the communication unit 301. Here, a disaster area is, for example, a range of 50 km×50 km centered on a source at which a disaster has occurred. The acquisition unit 303a acquires position information of a user who desires supply of fuel and who is located in the disaster area from the communication device 200 carried by the user who desires supply of fuel or the GPS sensor 120a of the vehicle 100 correlated with the communication device 200 via the network NW and the communication unit 301.

Subsequently, the identification unit 303b identifies a supply vehicle that can supply fuel out of a plurality of vehicles 100₁ to 100ₙ based on the amounts of residual fuel and the position information of the plurality of vehicles 100₁ to 100ₙ (Step S103). Specifically, first, the identification unit 303b identifies a stopped vehicle which has stopped or a disabled vehicle which is out of order out of the plurality of vehicles 100₁ to 100ₙ as the supply vehicle based on the state information of the plurality of vehicles 100₁ to 100ₙ. In this case, when there is a plurality of supply vehicles, the identification unit 303b may identify a stopped vehicle or a disabled vehicle of which the amount of residual fuel is equal to or greater than a predetermined value (for example, the amount of residual fuel in the fuel tank 114 is equal to or greater than 10%) as the supply vehicle.

Subsequently, the output control unit 303f outputs fuel supply request information for requesting supply of fuel to at least one of the supply vehicle and the communication device 200 correlated with the supply vehicle via the network NW and the communication unit 301 (Step S104). For example, the output control unit 303f outputs fuel supply request information including a message for requesting supply of fuel and a permission button for receiving an input of permission information for permitting supply of fuel to at least one of the supply vehicle and the communication device 200 correlated with the supply vehicle. Accordingly, a user who owns the supply vehicle can determine whether to supply fuel.

Thereafter, the determination unit 303c determines whether permission information for permitting supply fuel has been received from the supply vehicle and the communication device 200 correlated with the supply vehicle via the network NW and the communication unit 301 (Step S105). When the determination unit 303c determines that permission information for permitting supply of fuel has been received from the supply vehicle and the communication device 200 correlated with the supply vehicle (Step S105: YES), the support server 300 causes the routine to proceed to Step S106. On the other hand, when the determination unit 303c determines that permission information for permitting supply of fuel has not been received from the supply vehicle and the communication device 200 correlated with the supply vehicle (Step S105: NO), the support server 300 causes the routine to proceed to Step S106.

In Step S106, the output control unit 303f outputs unlocking information for unlocking a door to the supply vehicle having received the permission information. Accordingly, since the door of the supply vehicle is unlocked, a user who desires supply of fuel can be supplied or acquire fuel from the supply vehicle even when a supplier is neither in the supply vehicle nor in a standby state.

Subsequently, the provision unit 303d performs a provision process of providing electronic money or point corresponding to the amount of residual fuel or the amount of supplied fuel to one of a plurality of different means of payment which is registered in a wallet server representing deposit or withdrawal accounts for electronic money or point and which is operated by a plurality of business operators as a means of payment which a provider of fuel managed by the management server 400 has registered using the communication device 200 via the network NW and the communication unit 301 (Step S107).

Subsequently, the determination unit 303c determines whether sale request information for requesting sale of fuel has been received from the communication device 200 or the vehicle 100 via the network NW and the communication unit 301 (Step S108). When the determination unit 303c determines that sale request information for requesting sale of fuel has been received from the communication device 200 or the vehicle 100 via the network NW and the communication unit 301 (Step S108: YES), the support server 300 causes the routine to proceed to Step S109. On the other hand, when the determination unit 303c determines that sale request information for requesting sale of fuel has not been received from the communication device 200 or the vehicle 100 via the network NW and the communication unit 301 (Step S108: NO), the support server 300 causes the routine to proceed to Step S110.

In Step S109, the acquisition unit 303a acquires position information and an amount of residual fuel of the vehicle 100 correlated with the communication device 200 from which the sale request information has been received (hereinafter simply referred to as a “seller vehicle”).

Subsequently, the provision unit 303d performs a provision process of providing electronic money or point corresponding to the amount of residual fuel or the amount of supplied fuel to one of a plurality of different means of payment which is registered in a wallet server representing deposit or withdrawal accounts for electronic money or point and which is operated by a plurality of business operators as a means of payment which a seller of fuel managed by the management server 400 has registered using the communication device 200 via the network NW and the communication unit 301 (Step S110).

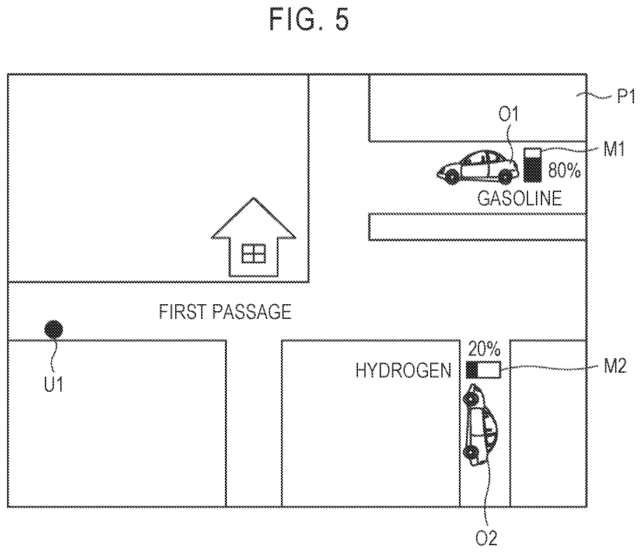

Thereafter, the generation unit 303e generates fuel position information based on the map data stored in the map data storage unit 302b, the position information and the amount of residual fuel of the supply vehicle identified by the identification unit 303b, and the position information and the amount of residual fuel of the vehicle 100 correlated with the communication device 200 of which the sale request information has been received (Step S111). FIG. 5 is a diagram illustrating an example of the fuel position information generated by the generation unit 303e. As illustrated in FIG. 5, the generation unit 303e generates fuel position information P1 based on the map data stored in the map data storage unit 302b, the position information and the amount of residual fuel of the supply vehicle identified by the identification unit 303b, and the position information and the amount of residual fuel of the vehicle 100 correlated with the communication device 200 of which the sale request information has been received. The fuel position information P1 includes positions of a supply vehicle O1 and a seller vehicle O2 in a predetermined range from a position of a user U1 and fuel types (gasoline or hydrogen) and amounts of residual fuel M1 and M2 of the supply vehicle O1 and the seller vehicle O2.

According to the aforementioned embodiment, the acquisition unit 303a acquires an amount of residual fuel of each of a plurality of vehicles 100₁ to 100ₙ, state information of each of the plurality of vehicles 100₁ to 100ₙ, position information of each of the plurality of vehicles 100₁ to 100ₙ, and user position information of a user who desires supply of fuel. The identification unit 303b identifies a supply vehicle that can supply fuel out of the plurality of vehicles 100₁ to 100ₙ based on the amounts of residual fuel of the plurality of vehicles 100₁ to 100ₙ and the state information of the plurality of vehicles 100₁ to 100ₙ. Thereafter, the generation unit 303e generates fuel position information including at least position information of the supply vehicle that can supply fuel based on the user position information acquired by the acquisition unit 303a and the position information of the supply vehicle identified by the identification unit 303b. Then, the output control unit 303f outputs the fuel position information generated by the generation unit 303e to the communication device 200 of a user who desires supply of fuel or the vehicle 100 correlated with the communication device of the user, whereby it is possible to cooperate with nearby vehicle 100.

According to the embodiment, the identification unit 303b identifies a stopped vehicle which has stopped or a disabled vehicle which is out of order out of the plurality of vehicles 100₁ to 100ₙ as the supply vehicle based on the state information of the plurality of vehicles 100₁ to 100ₙ. Accordingly, it is possible to supply of fuel from a stopped vehicle or a disabled vehicle which cannot be used for generation of electric power.

According to the embodiment, the output control unit 303f outputs information for inquiring about whether to permit supply of fuel to the communication device 200 correlated with the supply vehicle. When information indicating that supply of fuel is permitted has been received from the communication device 200 correlated with the supply vehicle, the output control unit 303f outputs unlocking information for unlocking a door of the supply vehicle to the supply vehicle. Accordingly, a user who desires supply of fuel can acquire fuel from the supply vehicle without having a key of the supply vehicle or the like.

According to the embodiment, when request information for requesting sale of fuel has been received by the support server 300, the acquisition unit 303a acquires position information of a seller vehicle correlated with the communication device 200 having transmitted the request information. The generation unit 303e generates fuel position information based on the position information of the seller vehicle, the user position information, and the position information of the supply vehicle. Accordingly, a user who desires supply of fuel can ascertain the position of the seller vehicle of a seller who desires sale of fuel.

According to the embodiment, the provision unit 303d performs a provision process of providing electronic money or point corresponding to the amount of residual fuel or the amount of supplied fuel to one of a plurality of different means of payment which is registered in a wallet representing deposit or withdrawal accounts for electronic money or point and which is operated by a plurality of business operators as a means of payment correlated with the communication device 200 of a supplier or a seller who supplies fuel. Accordingly, the supplier or the seller who supplies fuel can obtain electronic money or point by supplying fuel.

According to the embodiment, the fuel position information includes position information, a fuel type, and an amount of residual fuel of a supply vehicle. Accordingly, a user who desires supply of fuel can intuitively ascertain the position information, the fuel type, and the amount of residual fuel of the supply vehicle.

According to the embodiment, when the support server 300 receives disaster information, the output control unit 303f outputs fuel position information to a plurality of vehicles 100₁ to 100ₙ located in an area included in the disaster information. Accordingly, a user who is located in the area included in the disaster information and who desires supply of fuel can intuitively ascertain the position information of the supply vehicle.

According to the embodiment, the output control unit 303f outputs the fuel position information generated by the generation unit 303e to the communication device 200 of a user who desires supply of fuel or the vehicle 100 correlated with the communication device of the user, but may output only position information of a supply vehicle that can supply fuel and that is identified out of a plurality of vehicles 100₁ to 100ₙ by the identification unit 303b to the communication device 200 of a user who desires supply of fuel or the vehicle 100 correlated with the communication device of the user.

According to the embodiment, the support server 300 acquires various types of information from a plurality of vehicles 100₁ to 100ₙ via the network NW and outputs fuel position information to the communication device 200 of a user who desires supply of fuel or the vehicle 100 correlated with the communication device of the user, but the applicable embodiment is not limited thereto and, for example, the ECU 122 of the vehicle 100 may acquire various types of information and output the fuel position information to the communication device 200 of a user who desires supply of fuel or the vehicle 100 correlated with the communication device 200 of the user by performing inter-vehicle communication via the external communication unit 119.

### Other Embodiments

In the embodiment, “unit” can be replaced with “circuit.” For example, a control unit can be replaced with a control circuit.

A program that is executed by the disaster support system according to the embodiment is provided by recording the program as file data of an installable format or an executable format on a computer-readable storage medium such as a CD-ROM, a flexible disc (FD), a CD-R, a digital versatile disk (DVD), a USB medium, or a flash memory.

The program that is executed by the disaster support system according to the embodiment may be provided by storing the program in a computer connected to a network of Internet and downloading the program via the network.

In description with reference to the flowchart in this specification, the context of the steps is described using the expressions “first,” “thereafter,” and “subsequently,” but the order of steps required for realizing the embodiment is not uniquely determined by the expressions. That is, the order of steps in the flowchart described in this specification can be changed unless conflictions arise.

New advantages or modified examples can be easily conceived by those skilled in the art. A broader aspect of the applicable embodiment is not limited to specific details and representative embodiments described and illustrated above. Accordingly, the applicable embodiment can be modified in various forms without departing from the spirit or scope of the general concept of the present disclosure defined in the appended claims and equivalents thereto.

What is claimed is:

1. A support server comprising a processor configured to perform:
acquiring an amount of residual fuel, state information of each of a plurality of vehicles, position information of each of the plurality of vehicles, and user position information of a user who desires supply of fuel from the plurality of vehicles;
identifying a supply vehicle that is able to supply fuel out of the plurality of vehicles based on the amounts of residual fuel and the state information;
generating fuel position information including at least the position information of the supply vehicle based on the user position information and the position information of the supply vehicle; and
outputting the fuel position information.

2. The support server according to claim 1, wherein the processor is configured to identify a stopped vehicle which has stopped or a disabled vehicle which is out of order as the supply vehicle out of the plurality of vehicles based on the state information.

3. The support server according to claim 1, wherein the processor is configured to:
output information for inquiring about whether to permit the supply of fuel to a communication device correlated with the supply vehicle; and
output unlocking information for unlocking a door of the supply vehicle to the supply vehicle when information indicating that the supply of fuel is permitted is received from the communication device correlated with the supply vehicle.

4. The support server according to claim 1, wherein the processor is configured to:
acquire the position information of a seller vehicle correlated with a communication device having transmitted request information for requesting sale of fuel when the request information is received; and
generate the fuel position information based on the position information of the seller vehicle, the user position information, and the position information of the supply vehicle.

5. The support server according to claim 3, wherein the processor is configured to perform a provision process of providing electronic money or points corresponding to an amount of residual fuel or an amount of supplied fuel to a means of payment correlated with the communication device which is one of a plurality of different means of payment operated by a plurality of business operators and which is registered in a wallet representing a deposit or withdrawal account for electronic money or point.

6. The support server according to claim 1, wherein the fuel position information includes the position information of the supply vehicle, a type of fuel, and the amount of residual fuel.

7. The support server according to claim 1, wherein the processor is configured to output the fuel position information to the plurality of vehicles that is located in an area included in disaster information when the disaster information is received.

8. A disaster support system comprising:
a plurality of vehicles; and
a support server,
wherein the support server includes a processor configured to perform:
acquiring an amount of residual fuel, state information of each of a plurality of vehicles, position information of each of the plurality of vehicles, and user position information of a user who desires supply of fuel from the plurality of vehicles;
identifying a supply vehicle that is able to supply fuel out of the plurality of vehicles based on the amounts of residual fuel and the state information;
generating fuel position information including at least the position information of the supply vehicle based on the user position information and the position information of the supply vehicle; and
outputting the fuel position information.

9. A program causing a computer to perform:
acquiring an amount of residual fuel, state information of each of a plurality of vehicles, position information of each of the plurality of vehicles, and user position information of a user who desires supply of fuel from the plurality of vehicles;
identifying a supply vehicle that is able to supply fuel out of the plurality of vehicles based on the amounts of residual fuel and the state information;
generating fuel position information including at least the position information of the supply vehicle based on the user position information and the position information of the supply vehicle; and
outputting the fuel position information.
